(19) United States
(12) Patent Application Publication
(10) Pub. No.: US 2015/0185953 A1
(43) Pub. Date: Jul. 2, 2015

(54) OPTIMIZATION OPERATION METHOD AND APPARATUS FOR TERMINAL INTERFACE

(71) Applicant: Huawei Technologies Co., Ltd., Shenzhen (CN)

(72) Inventors: Xiaojuan MA, Hong Kong (HK); Yuan FANG, Shenzhen (CN); Wenyuan DAI, Hong Kong (HK)

(21) Appl. No.: 14/581,381

(22) Filed: Dec. 23, 2014

(30) Foreign Application Priority Data
Dec. 27, 2013 (CN) 201310740367.2

(51) Int. Cl. G06F 3/041; G06F 3/042

(52) U.S. Cl. CPC G06F 3/0416; G06F 3/0414; G06F 3/042

(57) ABSTRACT

Embodiments of the present invention provide an optimization operation method and apparatus for a terminal interface. The method includes: acquiring hand operation information of a user by using an sensing apparatus on the terminal; determining, according to the hand operation information, a hand-holding manner in operating the terminal by the user and a hand parameter; acquiring an interface parameter on a current operation interface of the touchscreen; determining an operation blind area on the operation interface according to the hand-holding manner, the hand parameter, and the interface parameter; and performing optimization processing on an element in the operation blind area, so that the user can operate the element in the operation blind area in the hand-holding manner.

### CROSS-REFERENCE TO RELATED APPLICATIONS

This application claims priority to Chinese Patent Application No. 201310740367.2, filed on Dec. 27, 2013, which is hereby incorporated by reference in its entirety.

### TECHNICAL FIELD

Embodiments of the present invention relate to the field of electronic technologies, and in particular, to an optimization operation method and apparatus for a terminal interface.

### BACKGROUND

Currently, mobile terminal devices such as smartphones and tablet computers are becoming increasingly popular. Most of these devices use large screens and are operated by using touchscreens. In order to bring better visual experience to users, a screen on a mobile terminal tends to become bigger. Besides bringing better visual experience to users, a mobile terminal brings new problems on user operations. For example, many users are used to operating a mobile phone with one hand, but for ordinary people, when they operate a mobile phone having a screen larger than four inches by using one hand, there is a part of area exceeding a touch range that fingers can reach. The touch range that the fingers cannot reach is also referred to as an operation blind area. Users need to complete an operation with both hands, which greatly affects user experience and reduces operation efficiency.

In the prior art, a position and a size of an element on an operation interface are fixed on touchscreens of most mobile phones. However, because users have different habits in holding and operating devices, a unified operation interface usually has an operation blind area that a user cannot touch. If a design is used to prevent placement of an operation element in an operation blind area, aesthetics and practicability of the operation interface may be affected, and efficiency of using the operation interface may also be reduced. In the prior art, Samsung Galaxy Note 3 provides a “tiny screen” mode for users to operate with one hand. When a user starts a one-hand operation option, the mobile phone provides a display interface that is smaller than an actual screen for the user in the “tiny screen” mode, and the user operates by using the small display interface.

However, in the prior art, a user generally needs to specify a hand-holding manner in settings in advance, that is, the user needs to manually specify that the user operates with one hand, which is inconvenient for user operations. In addition, because different users have different operation habits and different hand parameters (such as a length, a flexion-extension degree, or a movement range of a finger that is used to operate), an existing unified operation interface cannot meet personalized requirements of users.

### SUMMARY

Embodiments of the present invention provide an optimization operation method and apparatus for a terminal interface, so as to address a problem of inconvenience in operating a large-size touchscreen in the prior art.

A first aspect of the present invention provides an optimization operation method for a terminal interface, where the method is applied to a terminal that has a touchscreen, and the method includes:

acquiring hand operation information of a user by using a sensing apparatus on the terminal;

determining, according to the hand operation information, a hand-holding manner in operating the terminal by the user, and acquiring, according to the hand operation information, a hand parameter of a hand by which the user operates the terminal;

acquiring an interface parameter on a current operation interface of the touchscreen;

determining an operation blind area on the operation interface according to the hand-holding manner, the hand parameter, and the interface parameter, where the operation blind area is a range, which cannot be touched by the user in the hand-holding manner, on the operation interface; and

performing optimization processing on an element in the operation blind area, so that the user can operate the element in the operation blind area in the hand-holding manner.

In a first possible implementation manner of the first aspect of the present invention, the hand operation information is a touch operation signal that the user inputs by using the touchscreen and/or a sensing signal generated when the user holds the terminal.

In a second possible implementation manner of the first aspect of the present invention, the sensing apparatus is any one or a combination of the following apparatuses: a gyroscope, a pressure sensor, an optical sensor, and a touch sensor.

With reference to the first aspect and the first possible implementation manner and the second possible implementation manner of the first aspect of the present invention, in a third possible implementation manner of the first aspect of the present invention, the hand-holding manner includes any one or a combination of a two-hand operation, a one-hand operation, a hand-holding position, and a hand-holding direction; the two-hand operation specifically includes: holding the terminal with two hands and operating with two hands simultaneously, holding the terminal with the left hand and operating with the right hand, and holding the terminal with the right hand and operating with the left hand; and the one-hand operation includes: operating with the right hand or operating with the left hand.

With reference to the first aspect and the first possible implementation manner and the second possible implementation manner of the first aspect of the present invention, in a fourth possible implementation manner of the first aspect of the present invention, the hand parameter includes any one or a combination of the following information:

a finger length of the hand by which the user operates the terminal, a flexion-extension degree of the finger, a size of the finger, and a movement range of the finger.

With reference to the first aspect and the first possible implementation manner and the second possible implementation manner of the first aspect of the present invention, in a fifth possible implementation manner of the first aspect of the present invention, the interface parameter includes a size of the touchscreen and element information on the operation interface.

In a sixth possible implementation manner of the first aspect of the present invention, the performing optimization processing on an element in the operation blind area includes:

moving a part of or all elements in the operation blind area to an operable area on the operation interface, where the operable area is a range, except the operation blind area, on the operation interface.

In a seventh possible implementation manner of the first aspect of the present invention, after the moving a part of or all elements in the operation blind area to an operable area on the operation interface, the method further includes:

scaling down all elements in the operable area.

In an eighth possible implementation manner of the first aspect of the present invention, after the determining an operation blind area on the operation interface according to the hand-holding manner, the hand parameter, and the interface parameter, the method further includes:

predicting a next operation of the user according to element information on the operation interface and historical operation information of the user, where the historical operation information includes a hand operation record and a hand parameter record of the user;

determining whether an element corresponding to the next operation of the user is located in the operation blind area; and

if the element corresponding to the next operation of the user is located in the operation blind area, the performing optimization processing on an element in the operation blind area includes:

moving the element corresponding to the next operation of the user on the operation interface to the operable area, where the operable area is a range, except the operation blind area, on the operation interface.

In a ninth possible implementation manner of the first aspect of the present invention, after the moving the element on the operation interface to the operable area on the operation interface, the method further includes:

updating the historical operation information according to the hand-holding manner, the hand parameter, and an operation of the user.

In a tenth possible implementation manner of the first aspect of the present invention, the method further includes:

when it is detected that the hand-holding manner of the user changes, determining the changed hand parameter according to the changed hand-holding manner and historical operation information, where the historical operation information includes a hand operation record and a hand parameter record of the user;

determining a new operation blind area on a current new operation interface according to the changed hand-holding manner and the changed hand parameter; and

performing optimization processing on an element in the new operation blind area, so that the user can operate the element in the new operation blind area in the changed hand-holding manner.

A second aspect of the present invention provides an optimization operation apparatus for a terminal interface, where the apparatus is disposed in a terminal that has a touchscreen, and the apparatus includes:

a detecting module, configured to acquire hand operation information of a user by using a sensing apparatus on the terminal;

a hand-holding manner determining module, configured to determine, according to the hand operation information acquired by the detecting module, a hand-holding manner in operating the terminal by the user;

a hand parameter determining module, configured to acquire, according to the hand operation information acquired by the detecting module, a hand parameter of a hand by which the user operates the terminal;

an acquiring module, configured to acquire an interface parameter on a current operation interface of the touchscreen;

a blind area determining module, configured to determine an operation blind area on the operation interface according to the hand-holding manner, the hand parameter, and the interface parameter, where the operation blind area is a range, which cannot be touched by the user in the hand-holding manner, on the operation interface; and

an optimization processing module, configured to perform optimization processing on an element in the operation blind area determined by the blind area determining module, so that the user can operate the element in the operation blind area in the hand-holding manner.

In a first possible implementation manner of the second aspect of the present invention, the hand operation information is a touch operation signal that the user inputs by using the touchscreen and/or a sensing signal generated when the user holds the terminal.

In a second possible implementation manner of the second aspect of the present invention, the sensing apparatus is any one or a combination of the following apparatuses: a gyroscope, a pressure sensor, an optical sensor, and a touch sensor.

With reference to the second aspect and the first possible implementation manner and the second possible implementation manner of the second aspect of the present invention, in a third possible implementation manner of the second aspect of the present invention, the hand-holding manner includes any one or a combination of a two-hand operation, a one-hand operation, a hand-holding position, and a hand-holding direction, where the two-hand operation specifically includes: holding the terminal with two hands and operating with two hands simultaneously, holding the terminal with the left hand and operating with the right hand, and holding the terminal with the right hand and operating with the left hand; and the one-hand operation includes: operating with the right hand or operating with the left hand.

With reference to the second aspect and the first possible implementation manner and the second possible implementation manner of the second aspect of the present invention, in a fourth possible implementation manner of the second aspect of the present invention, the hand parameter includes any one or a combination of the following information:

a finger length of the hand by which the user operates the terminal, a flexion-extension degree of the finger, a size of the finger, and a movement range of the finger.

With reference to the second aspect and the first possible implementation manner and the second possible implementation manner of the second aspect of the present invention, in a fifth possible implementation manner of the second aspect of the present invention, the interface parameter includes a size of the touchscreen and element information on the operation interface.

In a sixth possible implementation manner of the second aspect of the present invention, the optimization processing module is specifically configured to:

move a part of or all elements in the operation blind area to an operable area on the operation interface, where the operable area is a range, except the operation blind area, on the operation interface.

In a seventh possible implementation manner of the second aspect of the present invention, after the optimization processing module moves a part of or all the elements in the operation blind area to the operable area on the operation interface, the optimization processing module is further configured to scale down all elements in the operable area.

In an eighth possible implementation manner of the second aspect of the present invention, the apparatus further includes:

an operation predicting module, configured to predict a next operation of the user according to element information on the operation interface and historical operation information of the user, where the historical operation information includes a hand operation record and a hand parameter record of the user, where

the operation predicting module is further configured to determine whether an element corresponding to the next operation of the user is located in the operation blind area; and

if the operation predicting module determines that the element corresponding to the next operation of the user is located in the operation blind area, the optimization processing module is specifically configured to:

move the element corresponding to the next operation of the user on the operation interface to the operable area, where the operable area is a range, except the operation blind area, on the operation interface.

In a ninth possible implementation manner of the second aspect of the present invention, the apparatus further includes:

an updating module, configured to update the historical operation information according to the hand-holding manner, the hand parameter, and an operation of the user.

In a tenth possible implementation manner of the second aspect of the present invention, the hand-holding manner determining module is further configured to detect whether the hand-holding manner of the user changes;

when the hand-holding manner determining module detects that the hand-holding manner of the user changes, the hand parameter module is further configured to determine the changed hand parameter according to the changed hand-holding manner and historical operation information, where the historical operation information includes a hand operation record and a hand parameter record of the user;

the blind area determining module is further configured to determine a new operation blind area on a current new operation interface according to the changed hand-holding manner and the changed hand parameter; and

the optimization processing module is further configured to perform optimization processing on an element in the new operation blind area, so that the user can operate the element in the new operation blind area in the changed hand-holding manner.

In an optimization operation method and apparatus for a terminal interface that are provided in embodiments of the present invention, a hand-holding manner in operating a terminal by a user, a hand parameter of a hand by which the user operates the terminal, and an interface parameter are acquired according to an operation of the user; an operation blind area on an operation interface is further determined according to the hand-holding manner, the hand parameter, and the interface parameter; and optimization processing is performed on an element in the operation blind area, so that the user can operate the element in the operation blind area in the hand-holding manner. By using the foregoing method, operability of the operation interface can be improved, and efficiency of using the operation interface is ensured. Moreover, user's participation is not required in an entire process, thereby facilitating use for the user. The method can adapt to different hand-holding manners and hand parameters of different users, thereby meeting personalized requirements of users.

### BRIEF DESCRIPTION OF DRAWINGS

FIG. 1 is a flowchart of Embodiment 1 of an optimization operation method for a terminal interface according to the present invention;

FIG. 2 is a schematic diagram of a hand parameter of holding and operating a terminal only with the right hand;

FIG. 3 is a schematic diagram of an operation blind area in three different hand-holding manners;

FIG. 4 is a flowchart of Embodiment 2 of an optimization operation method for a terminal interface according to the present invention;

FIG. 5 is a flowchart of Embodiment 3 of an optimization operation method for a terminal interface according to the present invention;

FIG. 6 is an operation schematic diagram of an application scenario of an optimization operation method for a terminal interface according to the present invention;

FIG. 7 is an operation schematic diagram of another application scenario of an optimization operation method for a terminal interface according to the present invention;

FIG. 8 is a schematic structural diagram of Embodiment 1 of an optimization operation apparatus for a terminal interface according to the present invention;

FIG. 9 is a schematic structural diagram of Embodiment 2 of an optimization operation apparatus for a terminal interface according to the present invention; and

FIG. 10 is a schematic structural diagram of a terminal according to an embodiment of the present invention.

### DESCRIPTION OF EMBODIMENTS

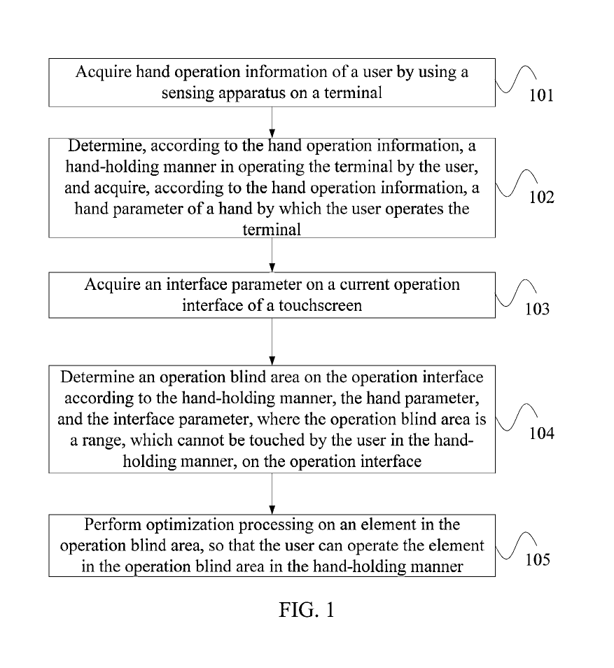

FIG. 1 is a flowchart of Embodiment 1 of an optimization operation method for a terminal interface according to the present invention. The method may be applied to a terminal that has a touchscreen, such as a mobile phone, a PDA (personal digital assistant, personal digital assistant), an MP3, an MP4, or a tablet computer. The optimization operation method for a terminal interface provided in this embodiment of the present invention is executed by the foregoing terminal, and may be specifically implemented by a module or a chip that has a processing function in the foregoing terminal, such as a CPU (central process unit, central processing unit). As shown in FIG. 1, the optimization operation method for a terminal interface provided in this embodiment includes the following steps:

Step 101: Acquire hand operation information of a user by using a sensing apparatus on the terminal.

The hand operation information may be a touch operation signal that the user inputs by using the touchscreen and/or a sensing signal generated when the user holds the terminal. In a process in which the user browses an operation interface on the touchscreen, an operation of the user can be detected by using the sensing apparatus. Specifically, the touchscreen has a two-dimensional or three-dimensional coordinate system. For any operation that the user inputs by using the touchscreen, coordinates corresponding to the operation may be acquired, so as to identify a position of the operation on the touchscreen. That is, an touch operation signal that the user inputs is acquired by using the sensing apparatus. Certainly, the sensing signal generated when the user holds the terminal may also be acquired by using the sensing apparatus. For example, the sensing signal generated when the user holds the terminal may be acquired by using sensing apparatuses that are disposed on both sides of the terminal. When the user operates the terminal with one hand and if the user uses the left hand, the left palm is in contact with a sensing apparatus on the left side of the terminal, and therefore the sensing signal is acquired. The sensing apparatus is any one or a combination of the following apparatuses: a gyroscope, a pressure sensor, an optical sensor, and a touch sensor.

Step 102: Determine, according to the hand operation information, a hand-holding manner in operating the terminal by the user, and acquire, according to the hand operation information, a hand parameter of a hand by which the user operates the terminal.

Firstly, the hand-holding manner in operating the terminal by the user is determined according to the hand operation information. The hand-holding manner includes any one or a combination of a two-hand operation, a one-hand operation, a hand-holding position, and a hand-holding direction. The two-hand operation specifically includes: holding the terminal with two hands and operating with two hands simultaneously, holding the terminal with the left hand and operating with the right hand, and holding the terminal with the right hand and operating with the left hand. The one-hand operation includes: operating with the right hand or operating with the left hand. The hand-holding position is a position at which the user holds the terminal, that is, the hand-holding position specifically determines whether the user currently holds the terminal by a top position, a middle position, or a bottom position. When the user holds the terminal by different positions, positions that the user can touch on the operation interface are different. The hand-holding direction specifically refers to whether a current operation interface of the user is in a landscape screen mode or a portrait screen mode. A position and a size of the operation interface that the user can touch when the current operation interface is in the landscape screen mode are different from those when the current operation interface is in the portrait screen mode.

Specifically, the hand-holding manner of the user may be determined according to a touch position, touch strength, a touch area, a touch angle, and the like of the user, which are detected by the sensing apparatus. For example, when the user uses different hand-holding manners, positions that the user can touch are different. For example, the position that can be touched when the user uses the left hand to operate is different from that when the user uses the right hand to operate. Therefore, the terminal may determine the hand-holding manner of the user by detecting the touch position of the user. In addition, when the user uses different hand-holding manners, the touch strength of the user is different, so that the hand-holding manner of the user may also be determined according to the touch position and the touch strength of the user. The following description is made by using a specific example. The hand-holding manner of the user may be determined by using the sensing apparatuses that are disposed on both sides of the terminal. When the user operates the terminal with one hand and if the user uses the left hand, the left palm is in contact with the sensing apparatus on the left side of the terminal. Therefore, it is determined that the user currently uses the left hand to operate, and the hand-holding position of the user can be accurately determined.

After the hand-holding manner in operating the terminal by the user is determined according to the hand operation information, the hand parameter of the hand by which the user operates the terminal is further acquired according to the hand operation information. Herein, the hand parameter includes any one or a combination of the following information: a finger length of the hand by which the user operates the terminal, a flexion-extension degree of the finger, a size of the finger, and a movement range of the finger. Specifically, the hand parameter may also be determined according to the touch position, the touch strength, the touch area, the touch angle, and the like of the user, which are detected by the sensing apparatus. For example, after it is determined that the hand-holding manner of the user is operating with the right hand, a hand parameter of the right hand is further determined according to a touch operation signal. If the user operates by using the thumb of the right hand, a length of the thumb, a flexion-extension degree of the finger, and a movement range of the finger are determined according to positions that the user touches at a longest distance and a shortest distance, and a size of the thumb is determined according to the touch area of the user. FIG. 2 is a schematic diagram of a hand parameter of holding and operating a terminal only with the right hand. FIG. 2(a) shows a size of a sector area (the sector area that is formed by dotted lines) in which the thumb of the right hand slides up and down on the touchscreen; FIG. 2(b) shows a flexion-extension degree (an angle formed by dotted lines) of the thumb of the right hand; and FIG. 2(c) shows a longest distance and a shortest distance that the thumb of the right hand can touch on the touchscreen.

It should be noted that the hand-holding manner and the hand parameter in this embodiment are only described as an example, and this embodiment of the present invention is not limited thereto.

Step 103: Acquire an interface parameter on a current operation interface of the touchscreen.

The interface parameter includes a size of the touchscreen and element information on the operation interface. The element information on the operation interface is, for example, layout of elements and an operation that may be triggered and executed.

Step 104: Determine an operation blind area on the operation interface according to the hand-holding manner, the hand parameter, and the interface parameter, where the operation blind area is a range, which cannot be touched by the user in the hand-holding manner, on the operation interface.

The operation blind area is a range, which cannot be touched by the user in the hand-holding manner, on the operation interface. When the user uses different hand-holding manners, ranges, which cannot be touched by the user, on the operation interface are different. In addition, hand parameters of different users are different. For example, a man, a woman, and a child have different sizes of palms and different lengths of fingers. Therefore, though users use a same hand-holding manner, different hand parameters may also cause sizes and ranges of operation blind areas to be different. In addition, when the operation blind area is determined, the interface parameter of the operation interface also needs to be taken into consideration. The interface parameter mainly refers to the size of the touchscreen, and touchscreens of different sizes have different operation blind areas. Therefore, in this embodiment, the operation blind area on the operation interface needs to be determined jointly according to the hand-holding manner, the hand parameter, and the interface parameter.

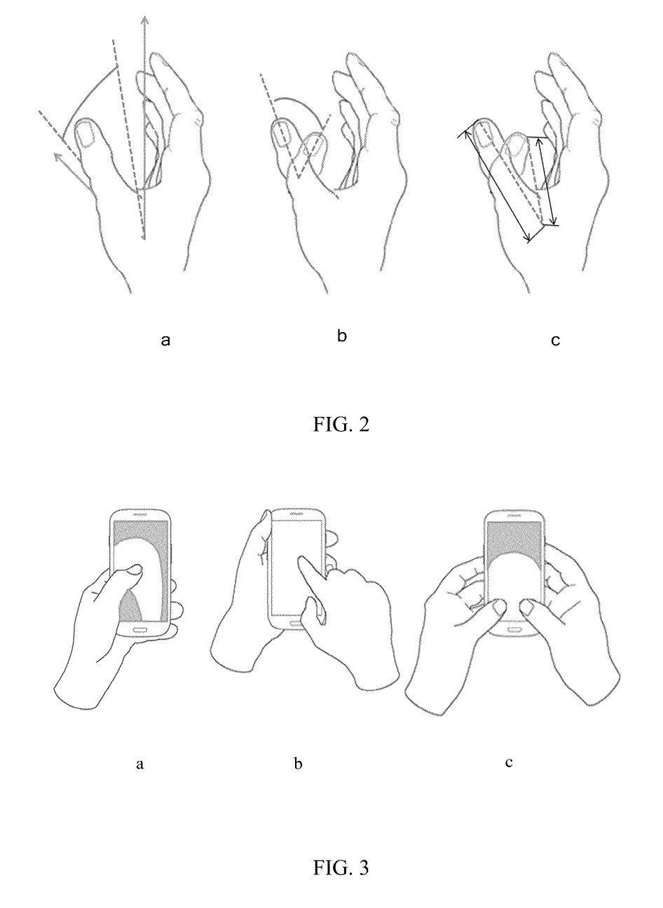

FIG. 3 is a schematic diagram of an operation blind area in three different hand-holding manners. As shown in FIG. 3(a), when the hand-holding manner is operating with the left hand, a user operates a terminal by using the thumb of the left hand. Affected by a flexion-extension degree and a length of the thumb of the left hand, an operation blind area of the terminal is a range that is shown by a gray area in FIG. 3(a). As shown in FIG. 3(b), when the hand-holding manner is operating with two hands, and the user holds the terminal by using the left hand and operates the terminal by using the index finger of the right hand, there is no operation blind area on the operation interface of the terminal. As shown in FIG. 3(c), when the hand-holding manner is operating with two hands, and the user holds the terminal with two hands and operates the terminal by using the thumbs of two hands, the operation blind area is a range that is shown by a gray area in FIG. 3(c).

Step 105: Perform optimization processing on an element in the operation blind area, so that the user can operate the element in the operation blind area in the hand-holding manner.

After the operation blind area is determined, optimization processing is performed on the element in the operation blind area. In an implementation manner, a part of or all elements in the operation blind area are moved to an operable area on the operation interface, where the operable area is a range, except the operation blind area, on the operation interface. A range that is shown by a white area in FIG. 3(a) is an operable area, and a range that is shown by a white area in FIG. 3(c) is also an operable area. After a part of or all elements in the operation blind area are moved to the operable area on the operation interface, all elements in the operable area are located in areas that the user can operate in a current handheld manner, making it convenient for the user to implement operations on the elements in the operable area. In another implementation manner, after a part of or all elements in the operation blind area are moved to the operable area on the operation interface, all elements in the operable area may further be scaled down. Because an area of the operable area is smaller than an area of the entire operation interface, in order to display all elements or a part of the elements in the operable area, all the elements in the operable area may be scaled down to a proper size, so that they can be displayed in the operable area without affecting normal use of the user. If the operable area cannot display all elements after a part of or all elements in the operation blind area are moved to the operable area on the operation interface, the elements may be displayed in a split-screen display manner, that is, in a multi-screen display manner. The user can display an element in a next screen by flicking the screen up and down or left and right in a display area.

In this embodiment, after the operation blind area is determined, the user does not need to perform any operation, and the terminal automatically performs optimization processing on the elements in the operation blind area, thereby bringing better experience to the user. In addition, it should be noted that the elements on the operation interface, which are mentioned in this embodiment of the present invention, specifically refer to various icons of applications, operation buttons, a menu bar, and a virtual keyboard in the applications, and the like.

In this embodiment, a hand-holding manner in operating a terminal by a user, a hand parameter of a hand by which the user operates the terminal, and an interface parameter are acquired according to an operation of the user; an operation blind area on an operation interface is further determined according to the hand-holding manner, the hand parameter, and the interface parameter; and optimization processing is performed on an element in the operation blind area, so that the user can operate the element in the operation blind area in the hand-holding manner. The foregoing method can improve operability of the operation interface and ensure efficiency of using the operation interface. Moreover, user's participation is not required in an entire process, thereby facilitating use for the user. The method can also adapt to different hand-holding manners and hand parameters of different users, thereby meeting personalized requirements of users.

The following describes in detail the technical solution of the method embodiment shown in FIG. 1 with reference to several specific embodiments.

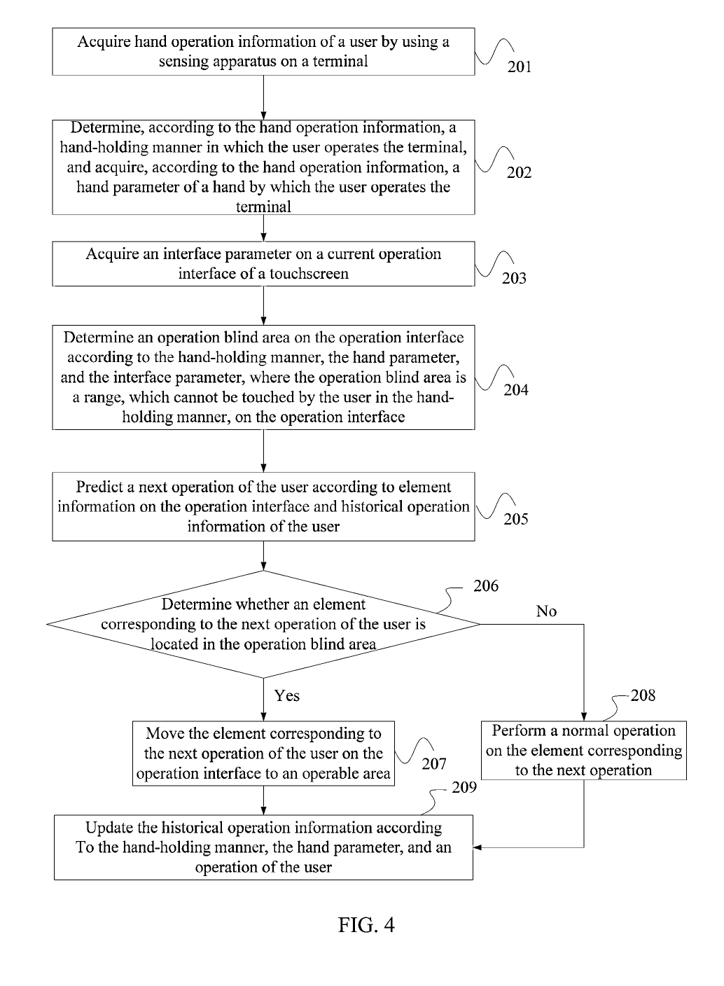

FIG. 4 is a flowchart of Embodiment 2 of an optimization operation method for a terminal interface according to the present invention. As shown in FIG. 4, the method in this embodiment may include the following steps:

Step 201: Acquire hand operation information of a user by using a sensing apparatus on the terminal.

Step 202: Determine, according to the hand operation information, a hand-holding manner in operating the terminal by the user, and acquire, according to the hand operation information, a hand parameter of a hand by which the user operates the terminal.

Step 203: Acquire an interface parameter on a current operation interface of a touchscreen.

Step 204: Determine an operation blind area on the operation interface according to the hand-holding manner, the hand parameter, and the interface parameter, where the operation blind area is a range, which cannot be touched by the user in the hand-holding manner, on the operation interface.

For specific implementation manners of steps 201 to 204, reference may be made to descriptions of steps 101 to 104 in Embodiment 1, and details are not described herein again.

Step 205: Predict a next operation of the user according to element information on the operation interface and historical operation information of the user.

The element information on the operation interface specifically refers to layout of elements, an operation that may be triggered and executed, and the like. The historical operation information includes a hand operation record and a hand parameter record of the user. Information about the hand operation record specifically includes a hand-holding manner that the user usually uses, a finger that is used to operate, a hand-holding position, and the like. Some operation habits of the user may be determined by means of a long-term study of user operations. For example, the user is used to operating with the right hand and operating by using the thumb of the right hand; in addition, when the user uses the right hand to operate, the user is used to holding the terminal by a lower position. The hand parameter record specifically refers to a length, a flexion-extension degree, and the like of the finger that the user uses to operate the terminal. The hand parameter may be acquired by means of the long-term study of the user operations. For the hand operation record and the hand parameter record of the user, these parameters may be constantly updated by means of actual operations of the user in a long term, so that the hand operation record and the hand parameter record are more accurate, and then the operation blind area can be determined more accurately. Historical record information further records corresponding hand parameters for different hand-holding manners used by the user, for example, a hand parameter of the thumb of the left hand when the user uses the left hand to operate.

A possible operation previously performed by the user on the operation interface can be determined according to the historical operation information and the element information on the operation interface. For example, according to the historical operation information, it can be learned that the user usually browses a web page, uses QQ, and plays games on the operation interface, but the number of times of browsing a web page and using QQ is greater than the number of times of playing games; therefore, according to the historical operation information and the element information on the operation interface, it is determined that next possible operations of the user are browsing a web page and using QQ.

Step 206: Determine whether an element corresponding to the next operation of the user is located in the operation blind area.

If the element corresponding to the next operation of the user is located in the operation blind area, step 207 is performed; if the element corresponding to the next operation of the user is not located in the operation blind area, step 208 is performed.

Step 207: Move the element corresponding to the next operation of the user on the operation interface to an operable area.

The operable area is a range, except the operation blind area, on the operation interface. Moving the element corresponding to the next operation of the user to the operable area facilitates use for the user, improves operability of the operation interface, and ensures efficiency of using the operation interface.

Step 208: Perform a normal operation on the element corresponding to the next operation.

Step 209: Update the historical operation information according to the hand-holding manner, the hand parameter, and an operation of the user.

In this embodiment, each time after the user completes an operation, the historical operation information is updated according to the hand-holding manner, the hand parameter, and the operation of the user. The historical operation information includes the hand operation record and the hand parameter record of the user. By means of constant corrections to the hand operation record of the user, a next operation of the user can be predicted more accurately, and by means of constant corrections to the hand parameter record of the user, the operation blind area of the terminal can be determined more accurately.

In this embodiment, an operation blind area on an operation interface is determined according to a hand-holding manner, a hand parameter, and an interface parameter, and optimization processing is performed on an element in the operation blind area, so that a user can operate the element in the operation blind area in the hand-holding manner. The foregoing method can improve operability of the operation interface and ensure efficiency of using the operation interface. Moreover, user's participation is not required in an entire process, thereby facilitating use for the user. In addition, in this embodiment, a hand operation record and a hand parameter record of the user are constantly updated by means of a long-term study of user operations, so that a next operation of the user can be predicted more accurately and an operation blind area of a terminal can be determined more accurately. The method can adapt to different operation habits of different users, thereby meeting personalized requirements of users.

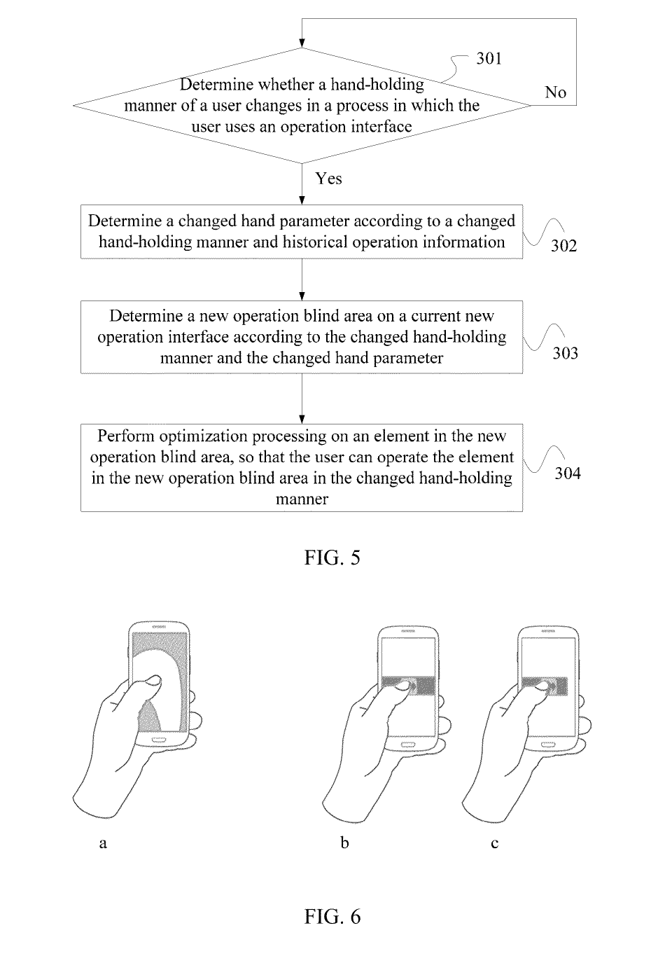

FIG. 5 is a flowchart of Embodiment 3 of an optimization operation method for a terminal interface according to the present invention. In this embodiment, how to adjust an operation blind area in a timely manner after a hand-holding manner or a hand parameter changes is described in detail on the basis of the foregoing Embodiment 1 and Embodiment 2. As shown in FIG. 5, the method in this embodiment may include the following steps:

Step 301: Determine whether a hand-holding manner of a user changes in a process in which the user uses an operation interface.

If the handheld manner of the user changes in the process in which the user uses the operation interface, step 302 is performed; if the handheld manner of the user does not change in the process in which the user uses the operation interface, step 301 is performed again. Specifically, whether the hand-holding manner of the user changes can be detected by using a sensing apparatus on a terminal. For example, the user first uses the right hand to operate the terminal and then uses two hands to operate the terminal. A change of the hand-holding manner of the user can be detected by using sensing apparatuses that are disposed on both sides of the terminal. For example, a pressure sensor is used. When the user operates the terminal by using the right hand, the pressure sensor detects that the right side of the terminal is under pressure, and it is determined that the user uses the right hand to operate. When the user operates by using two hands, the sensor detects that both the left side and the right side of the terminal are under pressure, and it is determined that the user uses two hands to operate.

Step 302: Determine a changed hand parameter according to a changed hand-holding manner and historical operation information.

When a result of the determining in step 301 is yes, that is, the hand-holding manner of the user changes, this step is performed. In this step, the changed hand parameter is determined according to the changed hand-holding manner and the historical operation information. The historical operation information includes a hand operation record of the user, a hand parameter record of the user, and a hand parameter corresponding to a different hand-holding manner that the user uses. Therefore, the changed hand parameter corresponding to the changed hand-holding manner of the user may be determined according to the historical operation information.

Step 303: Determine a new operation blind area on a current new operation interface according to the changed hand-holding manner and the changed hand parameter.

For a specific implementation manner, reference may be made to a description of step 104 in Embodiment 1, and details are not described herein again.

Step 304: Perform optimization processing on an element in the new operation blind area, so that the user can operate the element in the new operation blind area in the changed hand-holding manner.

For a specific implementation manner, reference may be made to a description of step 105 in Embodiment 1, and details are not described herein again.

In this embodiment, by means of dynamic detection of a change of a hand-holding manner of a user, a changed hand parameter is determined according to the change of the hand-holding manner of the user; a new operation blind area is further determined according to the changed hand-holding manner and the changed hand parameter; and optimization processing is performed on an element in the new operation blind area. In this way, an operation blind area can be adjusted in a timely manner according to a different hand-holding manner of the user, which brings better experience to the user.

The following describes in detail several typical application scenarios to which the present invention is applicable.

FIG. 6 is an operation schematic diagram of an application scenario of an optimization operation method for a terminal interface according to the present invention. As shown in FIG. 6, a user holds a large-screen mobile phone with the left hand and slides to unlock by using a thumb. FIG. 6(a) is a schematic diagram of an operation blind area when the user holds the mobile phone by using the left hand and operates the mobile phone by using the thumb. The operation blind area is a gray area in FIG. 6(a). In this embodiment, the mobile phone can dynamically adjust a length of a slider bar according to a position by which the user holds the mobile phone and a length of the thumb of the user, so as to ensure that the thumb can slide to a rightmost end of the slider bar. FIG. 6(b) is a schematic diagram of an operation interface before an optimization operation is performed. Before the optimization operation is performed, the length of the slider bar is a distance from the leftmost end to the rightmost end of a touchscreen. The rightmost end of the slider bar is in the operation blind area and cannot be touched by the thumb of the user, and the user needs to unlock by using two hands. FIG. 6(c) is a schematic diagram of an operation interface optimized by using the method provided in the present invention. After an element in the operation blind area is optimized, the rightmost end of the slider bar is located in an operable area of the operation interface, the thumb of the user can touch the rightmost end of the slider bar, and the user can also conveniently unlock by using one hand. If the user changes to hold the mobile phone with the left hand and operate with the index finger of the right hand, there is no operation blind area, and the length of the slider bar does not need to be changed.

An application scenario in which a user makes a call is used as an example below. In a process in which the user makes the call by holding a mobile phone with the right hand, if the user needs to input a password by using numeric keys, the method provided in the present invention can dynamically adjust a position of a numeric keyboard on the touchscreen and a size of the keyboard according to a position by which the user holds the mobile phone, a length of a finger of the user, a flexion-extension degree of the finger of the user, and a size of the finger of the user. If the user needs to take notes and shifts the mobile phone to the left hand in the call process, the position of the numeric keyboard on the touchscreen is also be accordingly adjusted and moved to another side of the screen.

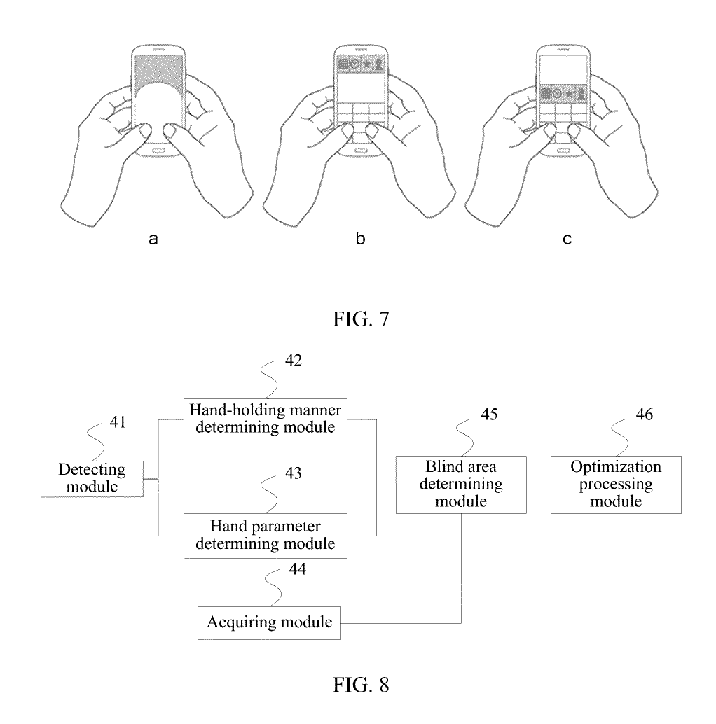

FIG. 7 is an operation schematic diagram of another application scenario of an optimization operation method for a terminal interface according to the present invention. As shown in FIG. 7, a user browses information by holding a mobile phone with two hands. FIG. 7(a) is a schematic diagram of an operation blind area when the user holds the mobile phone with two hands and operates the mobile phone with two hands, and the operation blind area is a gray area in FIG. 7(a). In the present invention, according to a position by which the user holds the mobile phone and a length of a finger that is used to operate, it can be determined that it is difficult for the user to touch a toolbar and a menu at a top of a touchscreen; therefore, the toolbar and the menu are dynamically adjusted to the middle of the touchscreen. FIG. 7(b) is a schematic diagram of an operation interface before an optimization operation is performed. Before the optimization operation is performed, the toolbar and the menu are located at the top of the touchscreen, and the toolbar and the menu are in the operation blind area. When the user operates with two hands, the toolbar and the menu cannot be touched. The user must move two hands to a middle position of the mobile phone, or hold the mobile phone with one hand and operate the mobile phone with the other hand, so as to touch the toolbar and the menu. FIG. 7(c) is a schematic diagram of an operation interface optimized by using the method provided in the present invention. After an element in the operation blind area is optimized, the toolbar and the menu at the top of the touchscreen are moved to the middle position of the mobile phone, and the toolbar and the menu are located in an operable area of the touchscreen, so that the user can operate the mobile phone without a need to change a hand-holding manner.

FIG. 8 is a schematic structural diagram of Embodiment 1 of an optimization operation apparatus for a terminal interface according to the present invention. The optimization operation apparatus for a terminal interface provided in this embodiment is disposed in a terminal that has a touchscreen. As shown in FIG. 8, the optimization operation apparatus for a terminal interface provided in this embodiment includes a detecting module 41, a hand-holding manner determining module 42, a hand parameter determining module 43, an acquiring module 44, a blind area determining module 45, and an optimization processing module 46.

The detecting module 41 is configured to acquire hand operation information of a user by using a sensing apparatus on the terminal;

the hand-holding manner determining module 42 is configured to determine, according to the hand operation information acquired by the detecting module 41, a hand-holding manner in operating the terminal by the user;

the hand parameter determining module 43 is configured to acquire, according to the hand operation information acquired by the detecting module 41, a hand parameter of a hand by which the user operates the terminal;

the acquiring module 44 is configured to acquire an interface parameter on a current operation interface of the touchscreen;

the blind area determining module 45 is configured to determine an operation blind area on the operation interface according to the hand-holding manner, the hand parameter, and the interface parameter, where the operation blind area is a range, which cannot be touched by the user in the hand-holding manner, on the operation interface; and

the optimization processing module 46 is configured to perform optimization processing on an element in the operation blind area determined by the blind area determining module 45, so that the user can operate the element in the operation blind area in the hand-holding manner.

In this embodiment, the hand operation information is a touch operation signal that the user inputs by using the touchscreen and/or a sensing signal generated when the user holds the terminal. The sensing apparatus is any one or a combination of the following apparatuses: a gyroscope, a pressure sensor, an optical sensor, and a touch sensor.

In this embodiment, the hand-holding manner includes any one or a combination of a two-hand operation, a one-hand operation, a hand-holding position, and a hand-holding direction, where the two-hand operation specifically includes: holding the terminal with two hands and operating with two hands simultaneously, holding the terminal with the left hand and operating with the right hand, and holding the terminal with the right hand and operating with the left hand; and the one-hand operation includes: operating with the right hand or operating with the left hand. The hand parameter includes any one or a combination of the following information: a finger length of the hand by which the user operates the terminal, a flexion-extension degree of the finger, a size of the finger, and a movement range of the finger. The interface parameter includes a size of the touchscreen and element information on the operation interface.

In this embodiment, the optimization processing module 46 is specifically configured to move a part of or all elements in the operation blind area to an operable area on the operation interface, where the operable area is a range, except the operation blind area, on the operation interface. After the optimization processing module 46 moves a part of or all elements in the operation blind area to the operable area on the operation interface, the optimization processing module 46 is further configured to scale down all elements in the operable area.

The apparatus in this embodiment may be used to implement the technical solution in the first method embodiment. Implementation principles and technical effects of the apparatus are similar to those of the method embodiment, and are not described herein again.

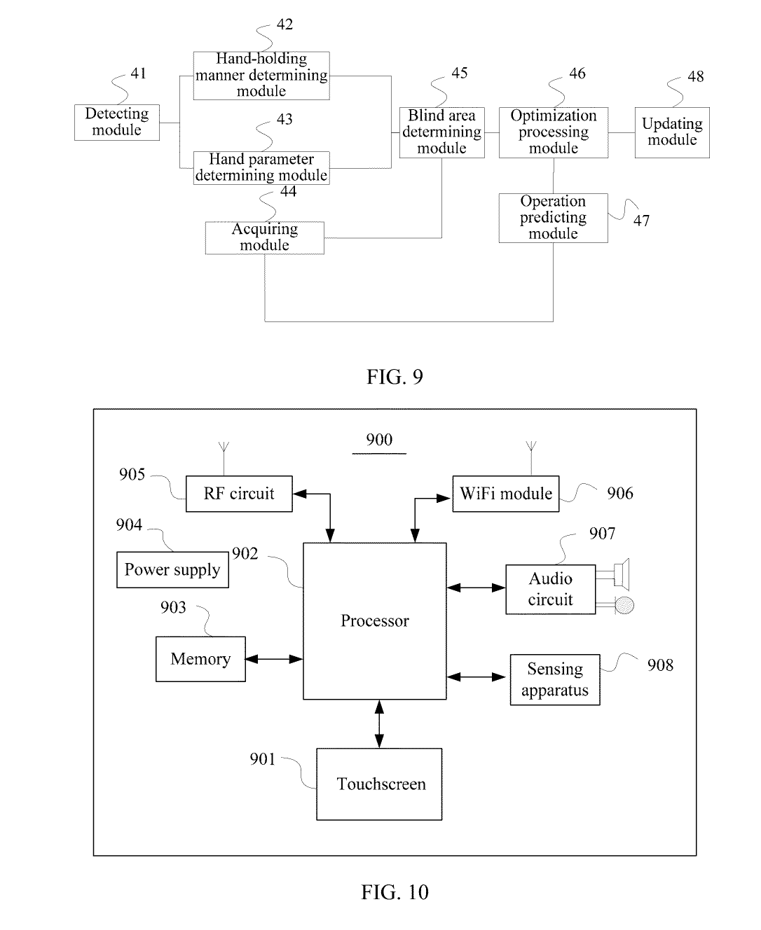

FIG. 9 is a schematic structural diagram of Embodiment 2 of an optimization operation apparatus for a terminal interface according to the present invention. As shown in FIG. 9, on the basis of a structure of the apparatus shown in FIG. 8, the apparatus provided in this embodiment may further include an operation predicting module 47 and an updating module 48.

The operation predicting module 47 is configured to predict a next operation of a user according to element information on an operation interface and historical operation information of the user, where the historical operation information includes a hand operation record and a hand parameter record of the user.

The operation predicting module 47 is further configured to determine whether an element corresponding to the next operation of the user is located in an operation blind area.

If the operation predicting module 47 determines that the element corresponding to the next operation of the user is located in the operation blind area, an optimization processing module 46 is specifically configured to move the element corresponding to the next operation of the user on the operation interface to an operable area, where the operable area is a range, except the operation blind area, on the operation interface.

In this embodiment, a hand-holding manner determining module 42 is further configured to detect whether a hand-holding manner of the user changes. When the hand-holding manner determining module 42 detects that the hand-holding manner of the user changes, a hand parameter determining module 43 is further configured to determine a changed hand parameter according to a changed hand-holding manner and the historical operation information, where the historical operation information includes the hand operation record and the hand parameter record of the user. A blind area determining module 45 is further configured to determine a new operation blind area on a current new operation interface according to the changed hand-holding manner and the changed hand parameter. The optimization processing module 46 is further configured to perform optimization processing on an element in the new operation blind area, so that the user can operate the element in the new operation blind area in the changed hand-holding manner.

The apparatus in this embodiment may be used to implement the technical solutions in the first to third method embodiments. Implementation principles and technical effects of the apparatus are similar to those of the method embodiments, and are not described herein again.

FIG. 10 is a schematic structural diagram of a terminal according to an embodiment of the present invention. As shown in FIG. 10, the terminal provided in this embodiment may be used to implement the methods in Embodiment 1 to Embodiment 3 of the present invention. For ease of description, only a part relevant to this embodiment of the present invention is illustrated. For specific technical details that are not disclosed, refer to descriptions in Embodiment 1 to Embodiment 3. The terminal may be a device that has a touchscreen, such as a mobile phone, a tablet computer, a PDA, a POS machine, or a vehicle-mounted computer.

In this embodiment, only components that relate to an optimization operation method for a terminal interface are described. Specifically, a memory 903 may be configured to store a software program and a module, and a processor 902 implements, by running the software program and the module that are stored in the memory 903, the optimization operation method for a terminal interface provided in this embodiment of the present invention.

That the terminal is a mobile phone is used as an example in this embodiment, and FIG. 10 is a block diagram of a partial structure of a mobile phone 900 provided in this embodiment of the present invention. Referring to FIG. 10, the mobile phone 900 specifically includes components such as a touchscreen 901, the processor 902, the memory 903, a power supply 904, an RF (Radio Frequency, radio frequency) circuit 905, a WiFi (wireless fidelity, wireless fidelity) module 906, an audio circuit 907, and a sensing apparatus 908. Persons skilled in the art may understand that a structure of the mobile phone shown in FIG. 10 constitutes no limitation on the mobile phone, and instead, the mobile phone may include components more or fewer than those shown in FIG. 10, or a combination of some components, or components disposed differently. The mobile phone 900 may further include a camera, a Bluetooth module, and the like, which are not shown in the diagram though and are not repeatedly described herein.

The touchscreen 901 may be configured to receive a split-screen touch signal and digit or character information that are input by the user, and generate a key signal input related to a user setting and function control of the mobile phone 900. The touchscreen 901 can acquire a touch operation (such as an operation performed by the user on the touchscreen by using a finger, a touch pen, or any proper object or accessory) of the user on the touchscreen 901, and drive a corresponding connection apparatus according to a preset program. The touchscreen 901 sends an acquired touch signal and other signals to the processor 902, and can receive and execute a command sent by the processor 902. In this embodiment, the touchscreen 901 not only has an input function but also has a display function, and can display a corresponding result to the user according to a processing result of the processor.

The processor 902, which is a control center of the mobile phone, is connected to each part of the entire mobile phone by using various interfaces and lines, and implements various functions of the mobile phone 900 and data processing by running or executing the software program and/or the module that are/is stored in the memory 903 and invoking data stored in the memory 903. Preferably, an application processor and a modem processor may be integrated into the processor 902, where the application processor primarily handles an operating system, a user interface, an application, and the like, and the modem processor primarily handles wireless communication. It should be understood that the modem processor may also be not integrated into the processor 902.

In this embodiment, the touchscreen 901 and the processor 902 specifically have the following functions:

The touchscreen 901 is configured to acquire hand operation information of the user by using the sensing apparatus 908 on the terminal, where the hand operation information is a touch operation signal that the user inputs by using the touchscreen and/or a sensing signal generated when the user holds the terminal. The sensing apparatus 908 is any one or a combination of the following apparatuses: a gyroscope, a pressure sensor, an optical sensor, and a touch sensor.

The processor 902 is configured to determine, according to the hand operation information acquired by the touchscreen 901, a hand-holding manner in operating the terminal by the user, and acquire, according to the hand operation information, a hand parameter of a hand by which the user operates the terminal.

The processor 902 is further configured to acquire an interface parameter on a current operation interface of the touchscreen; determine an operation blind area on the operation interface according to the hand-holding manner, the hand parameter, and the interface parameter, where the operation blind area is a range, which cannot be touched by the user in the hand-holding manner, on the operation interface; and perform optimization processing on an element in the operation blind area, so that the user can operate the element in the operation blind area in the hand-holding manner.

In this embodiment, the hand-holding manner includes any one or a combination of a two-hand operation, a one-hand operation, a hand-holding position, and a hand-holding direction, where the two-hand operation specifically includes: holding the terminal with two hands and operating with two hands simultaneously, holding the terminal with the left hand and operating with the right hand, and holding the terminal with the right hand and operating with the left hand; and the one-hand operation includes: operating with the right hand or operating with the left hand. The hand parameter includes any one or a combination of the following information: a finger length of the hand by which the user operates the terminal, a flexion-extension degree of the finger, a size of the finger, and a movement range of the finger. The interface parameter includes a size of the touchscreen and element information on the operation interface.

The processor 902 performs optimization processing on the element in the operation blind area. Specifically, the processor 902, by controlling the touchscreen 901, moves a part of or all elements in the operation blind area to an operable area on the operation interface, where the operable area is a range, except the operation blind area, on the operation interface. After moving a part of or all elements in the operation blind area to the operable area on the operation interface, the processor 902 is further configured to scale down all elements in the operable area.

In this embodiment, the processor 902 is further configured to predict a next operation of the user according to the element information on the operation interface and historical operation information of the user, where the historical operation information includes a hand operation record and a hand parameter record of the user. After the next operation of the user is predicted, the processor 902 determines whether an element corresponding to the next operation of the user is located in the operation blind area. If the element corresponding to the next operation of the user is located in the operation blind area, the processor 902 moves the element corresponding to the next operation of the user on the operation interface to the operable area, where the operable area is the range, except the operation blind area, on the operation interface.

After moving the element on the operation interface to the operable area on the operation interface, the processor 902 is further configured to update the historical operation information according to the hand-holding manner, the hand parameter, and an operation of the user, where the historical operation information may be stored in the memory 903.

To adapt to various changes of the hand-holding manner of the user, the processor 902 in this embodiment is further configured to determine a changed hand parameter according to a changed hand-holding manner and the historical operation information when it is detected that the hand-holding manner of the user changes, where the historical operation information includes the hand operation record and the hand parameter record of the user; determine a new operation blind area on a new operation interface according to the changed hand-holding manner and the changed hand parameter; and then perform optimization processing on an element in the new operation blind area, so that the user can operate the element in the new operation blind area in the changed hand-holding manner.

The terminal provided in this embodiment may be used to implement a method in any embodiment of the present invention.

The embodiments in this specification are all described in a progressive manner, for same or similar parts in the embodiments, reference may be made to these embodiments, and each embodiment focuses on a difference from other embodiments. Especially, an apparatus embodiment is basically similar to a method embodiment, and therefore is described briefly; for related parts, reference may be made to partial descriptions in the method embodiment. The described apparatus embodiment is merely exemplary. The units described as separate parts may or may not be physically separate, and parts displayed as units may or may not be physical units, may be located in one position, or may be distributed on a plurality of network units. A part of or all the modules may be selected according to actual needs to achieve the objectives of the solutions of the embodiments. Persons of ordinary skill in the art may understand and implement the embodiments of the present invention without creative efforts.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part of or all the units may be selected according to actual needs to achieve the objectives of the solutions of the embodiments. Functional units in the embodiments of the present invention may be integrated into one processing unit, or each of the units may exist alone physically, or two or more units are integrated into one unit. In the accompanying drawings of the apparatus embodiments provided in the present invention, a connection relationship between modules indicates that a communication connection exists between them, which may be specifically implemented as one or more communications buses or signal cables. Persons of ordinary skill in the art may understand and implement the embodiments of the present invention without creative efforts. Based on the foregoing descriptions of the embodiments, persons skilled in the art may clearly understand that the present invention may be implemented by software in addition to necessary universal hardware or by dedicated hardware only, including a dedicated integrated circuit, a dedicated CPU, a dedicated memory, a dedicated component and the like. Generally, any functions that can be performed by a computer program can be easily implemented by using corresponding hardware. Moreover, a specific hardware structure used to achieve a same function may be of various forms, for example, in a form of an analog circuit, a digital circuit, a dedicated circuit, or the like. However, as for the present invention, software program implementation is a better implementation manner in most cases. Based on such an understanding, the technical solutions of the present invention essentially or the part contributing to the prior art may be implemented in a form of a software product. The software product is stored in a readable storage medium, such as a floppy disk, a USB flash drive, a removable hard disk, a read-only memory (ROM, Read-Only Memory), a random access memory (RAM, Random Access Memory), a magnetic disk, or an optical disc of a computer, and includes several instructions for instructing a computer device (which may be a personal computer, a server, a network device, and the like) to perform the methods described in the embodiments of the present invention.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. An optimization method for a terminal interface, the method comprising:
acquiring hand operation information of a user by using a sensing apparatus on the terminal;
determining, according to the hand operation information, a hand-holding manner of operating the terminal by the user, and acquiring, according to the hand operation information, a hand parameter of a hand by which the user operates the terminal;
acquiring an interface parameter on a current operation interface of a touchscreen of the terminal;
determining an operation blind area on the operation interface according to the hand-holding manner, the hand parameter, and the interface parameter, wherein the operation blind area is a range of the operation interface that cannot be touched by the user in the hand-holding manner; and
performing optimization processing on an element in the operation blind area, so that the user can operate the element in the operation blind area in the hand-holding manner.

2. The method according to claim 1, wherein the hand operation information comprises any one or a combination of the following information:
a touch operation signal that the user inputs by using the touchscreen and a sensing signal generated when the user holds the terminal.

3. The method according to claim 1, wherein the sensing apparatus is any one or a combination of the following apparatuses:
a gyroscope, a pressure sensor, an optical sensor, and a touch sensor.

4. The method according to claim 1, wherein the hand parameter comprises any one or a combination of the following information:
a finger length of the hand by which the user operates the terminal, a flexion-extension degree of the finger, a size of the finger, and a movement range of the finger.

5. The method according to claim 1, wherein the interface parameter comprises a size of the touchscreen and element information on the operation interface.

6. The method according to claim 1, wherein performing optimization processing on the element in the operation blind area comprises:
moving a part of or all elements in the operation blind area to an operable area on the operation interface.

7. The method according to claim 6, wherein after the moving a part of or all elements in the operation blind area to the operable area on the operation interface, the method further comprises:
scaling down all elements in the operable area.

8. The method according to claim 1, wherein after determining the operation blind area on the operation interface, the method further comprises:
predicting a next operation of the user according to element information on the operation interface and historical operation information of the user, wherein the historical operation information comprises a hand operation record and a hand parameter record of the user;
determining whether an element corresponding to the next operation of the user is located in the operation blind area; and
in response to determining that the element corresponding to the next operation of the user is located in the operation blind area, performing optimization processing on an element in the operation blind area which comprises: moving the element corresponding to the next operation of the user on the operation interface to an operable area.

9. The method according to claim 1, further comprising:
in response to detecting that the hand-holding manner of the user changes, determining a changed hand parameter according to a changed hand-holding manner and historical operation information, wherein the historical operation information comprises a hand operation record and a hand parameter record of the user;
determining a new operation blind area on a current new operation interface according to the changed hand-holding manner and the changed hand parameter; and
performing optimization processing on an element in the new operation blind area, so that the user can operate the element in the new operation blind area in the changed hand-holding manner.

10. An terminal, comprising:
a detecting module, configured to acquire hand operation information of a user by using a sensing apparatus on the terminal;
a hand-holding manner determining module, configured to determine, according to the hand operation information acquired by the detecting module, a hand-holding manner of operating the terminal by the user;
a hand parameter determining module, configured to acquire, according to the hand operation information acquired by the detecting module, a hand parameter of a hand by which the user operates the terminal;
an acquiring module, configured to acquire an interface parameter on a current operation interface of a touchscreen of the terminal;
a blind area determining module, configured to determine an operation blind area on the operation interface according to the hand-holding manner, the hand parameter, and the interface parameter, wherein the operation blind area is a range of the operation interface that cannot be touched by the user in the hand-holding manner; and
an optimization processing module, configured to perform optimization processing on an element in the operation blind area determined by the blind area determining module, so that the user can operate the element in the operation blind area in the hand-holding manner.

11. The terminal according to claim 10, wherein the hand operation information comprises any one or a combination of the following information:
a touch operation signal that the user inputs by using the touchscreen and a sensing signal generated when the user holds the terminal.

12. The terminal according to claim 10, wherein the sensing apparatus is any one or a combination of the following apparatuses:
a gyroscope, a pressure sensor, an optical sensor, and a touch sensor.

13. The terminal according to claim 10, wherein the hand parameter comprises any one or a combination of the following information:
a finger length of the hand by which the user operates the terminal, a flexion-extension degree of the finger, a size of the finger, and a movement range of the finger.

14. The terminal according to claim 10, wherein the interface parameter comprises a size of the touchscreen and element information on the operation interface.

15. The terminal according to claim 10, wherein the optimization processing module is configured to:
move a part of or all elements in the operation blind area to an operable area on the operation interface so that the user can operate the element in the operation blind area in the hand-holding manner.

16. The terminal according to claim 15, wherein after the optimization processing module moves a part of or all elements in the operation blind area to the operable area on the operation interface, the optimization processing module is further configured to scale down all elements in the operable area.

17. The terminal according to claim 10, further comprising:
an operation predicting module, configured to predict a next operation of the user according to element information on the operation interface and historical operation information of the user, wherein the historical operation information comprises a hand operation record and a hand parameter record of the user,
wherein the operation predicting module is further configured to determine whether an element corresponding to the next operation of the user is located in the operation blind area; and
wherein in response to the operation predicting module determining that the element corresponding to the next operation of the user is located in the operation blind area, the optimization processing module is configured to move the element corresponding to the next operation of the user on the operation interface to an operable area.

18. The terminal according to claim 16, wherein the hand-holding manner determining module is further configured to detect whether the hand-holding manner of the user changes;
when the hand-holding manner determining module detects that the hand-holding manner of the user changes, the hand parameter module is further configured to determine the changed hand parameter according to a changed hand-holding manner and historical operation information, wherein the historical operation information comprises a hand operation record and a hand parameter record of the user;
the blind area determining module is further configured to determine a new operation blind area on a current new operation interface according to the changed hand-holding manner and the changed hand parameter; and
the optimization processing module is further configured to perform optimization processing on an element in the new operation blind area, so that the user can operate the element in the new operation blind area in the changed hand-holding manner.
